(19) United States
(12) Patent Application Publication
(10) Pub. No.: US 2009/0184947 A1
(43) Pub. Date: Jul. 23, 2009

(54) Color calibration system and method

(76) Inventors: Paul M. Hupman, Magnolia, TX (US); Joseph M. Driear, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/009,753

(22) Filed: Jan. 22, 2008

(51) Int. Cl. G09G 5/00

(52) U.S. Cl. 345/207

(57) ABSTRACT

A color calibration system comprises an electronic device having a display screen, a color sensing device disposed on the electronic device, and a calibration module disposed in the electronic device to perform a color calibration process for the display screen based on a color value detected by the color sensing device.

### BACKGROUND

The color quality of display monitors typically degrades over time and requires adjustments in order to maintain factory level color quality. Peripheral calibration devices currently exist to detect color degradation for display monitors. However, the calibration devices are typically cumbersome requiring the device to be precisely placed over the display monitor to obtain an accurate reading. Furthermore, since calibration adjustments are conducted periodically, the calibration device is an additional device that the user must generally purchase and/or maintain.

### BRIEF DESCRIPTION OF THE DRAWINGS

FIG. 1 illustrates a color calibration system for an electronic device;

FIG. 2 is a block diagram illustrating an embodiment of the color calibration system of FIG. 1; and

FIG. 3 illustrates an embodiment of a color calibration method for an electronic device display.

### DETAILED DESCRIPTION OF THE DRAWINGS

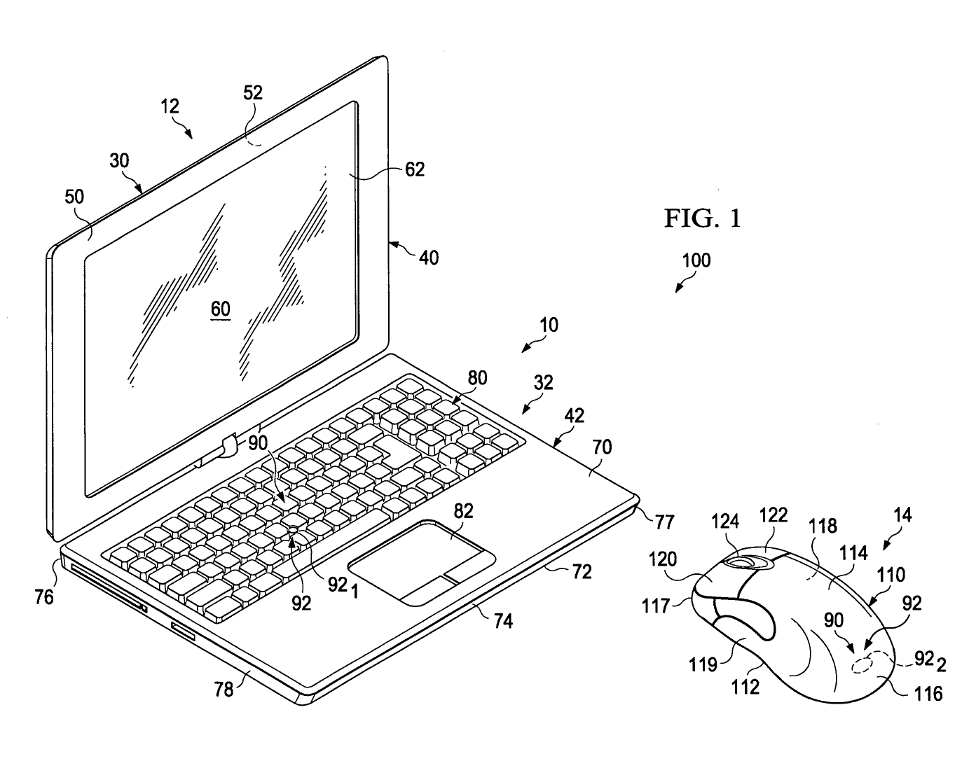

FIG. 1 illustrates a color calibration system 100 for an electronic device 10. System 100 is configured to determine a current color displayed on a display screen for electronic device 10 and identify possible color degradation on a viewable surface of the display screen of electronic device 10. In FIG. 1, electronic device 10 is coupled to an external input device (e.g., a mouse 14). In FIG. 1, electronic device 10 is a laptop or notebook computer 12. However, it should be understood that electronic device 10 can be any type of electronic device such as, but not limited to, a desktop computer, a tablet computer, a personal digital assistant (PDA), a phone or any other type of portable or non-portable electronic device.

In the illustrated embodiment, electronic device 10 comprises a display member 30 rotably coupled to a base member 32. Display member 30 and base member 32 each comprise housings 40 and 42, respectively, for housing and/or supporting one or more components of electronic device 10. For example, in the illustrated embodiment housing 40 comprises a front wall 50 and a rear wall 52 for supporting a display screen 60. Housing 42 of base member 32 comprises a working surface 70, a bottom wall 72, a front wall 74, a back wall 76 and side walls 77 and 78. In FIG. 1, working surface 70 comprises a keyboard 80 and a touch pad 82. However, it should be understood that working surface 70 may also comprise more or fewer components and/or devices than illustrated. In FIG. 1, base member 32 also comprises interfaces for various user interface components disposed along any of working surface 70 and walls 72, 74, 76, 77 and 78.

Mouse 14 is a pointing device configured to provide user input to electronic device 10. In FIG. 1, mouse 14 comprises a housing 110 having a bottom wall 112, a top wall 114, a back wall 116, a front wall 117, and side walls 118 and 119. Bottom wall 112 may comprises various optical features configured to detect a physical movement of mouse 14 relative to a support surface. Top wall 114 comprises various user interfaces (e.g., a left mouse button 120, a right mouse button 122, and a scroll wheel 124) configured to enable the selection and/or movement of various graphical objects presented on display screen 60 using mouse 14. Display screen 60 comprises a viewable surface 62 configured to enable display of a graphical image and/or display input received by a user (e.g., movement of a cursor caused by movement of mouse 14).

In FIG. 1, system 100 comprises a calibration system 90 configured to identify and correct detected color degradation of display screen 60. Calibration system 90 comprises at least one sensing device 92 configured to determine a current color displayed on display screen 60 of electronic device 10. In the illustrated embodiment, two sensing devices 92 are shown with one sensing device 92 embodied within keyboard 80 as sensing device 92₁ and another sensing device 92 embodied within mouse 14 as sensing device 92₂. However, it should be understood that sensing device 92 may be disposed within any other type of user input devices (e.g., a light pen, a trackball, or other type of input device that is generally used to provide input to electronic device 10 other than color detection information). In FIG. 1, sensing device 92₁ is disposed between keys of keyboard 80 in a substantially central position within keyboard 80, and sensing device 92₂ is illustrated in phantom as being disposed along bottom wall 112 of mouse 14. However, it should be understood that sensing devices 92₁ and 92₂ may be disposed respectively in any portion of keyboard 80 and along any of walls 114, 116, 117, 118, and 119 of mouse 14.

Thus, in operation, calibration system 90 detects any color degradation of display screen 60. Sensing device 92 reads a light frequency emitted from a portion of display screen 60 to determine the current color being displayed on display screen 60. In FIG. 1, electronic device 10 is illustrated in an open position. In some embodiments, calibration system 90 and sensing device 92₁ initiate when electronic device is in a closed position. A “closed position,” as used herein, is defined as a position when display member 30 is adjacent to base member 32 such that display screen 60 is adjacent and/or next to keyboard 80 (e.g., facing keyboard 80). Thus, in operation, when electronic device 10 is in a closed position, sensing device 92₁ reads a light frequency emitted from a portion of display screen 60 to determine the current color being displayed on display screen 60. In some embodiments, sensing device 92₂ initiates when mouse 14 is placed adjacent to and/or next to viewable surface 62 of display screen 60. In this embodiment, sensing device 92₂ reads a light frequency emitted from a portion of display screen 60 where mouse 14 is placed and transmits the detected frequency information to electronic device 10 (e.g., by a hardwired connection or wirelessly). The current color readings by sensing devices 92₁ and/or 92₂ are then compared against an expected color value to determine whether display color degradation exists. Based on the amount of degradation, system 100 can then calibrate and/or adjust the colors being displayed by display screen 60 so that the displayed colors are in accordance with desired and/or predetermined values. It should be understood that initialization of system 90 and one or more sensing devices 92 may be by user request and/or automatically based on a predetermined schedule or interval (e.g., displaying a prompt on display screen 60 for the user to close electronic device 10 for some period of time while calibration is performed).

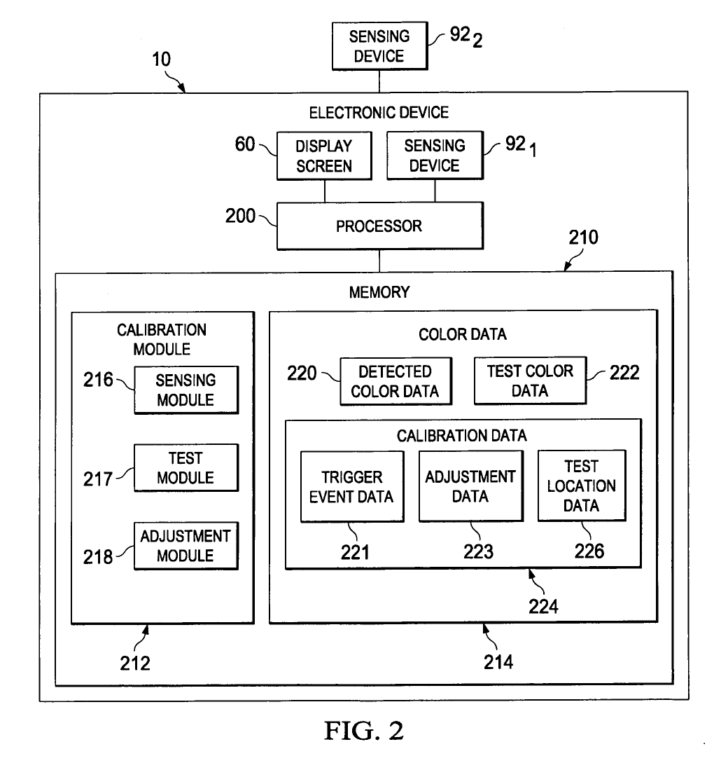

FIG. 2 is a block diagram illustrating an embodiment of color calibration system 100. Components of system 100 may comprise software, hardware, firmware, or a combination thereof. In FIG. 2, electronic device 10 comprises sensing device 92, display screen 60, a processor 200, and a memory 210. Memory 210 comprises calibration module 212 and color data 214. In FIG. 2, calibration module 212 is illustrated as being stored in memory 210 so as to be accessible and/or executable by processor 200. However, it should be understood that a portion and/or substantially all of calibration module 212 may be otherwise stored (e.g., in an external memory component). In FIG. 2, calibration module 212 is configured to initiate and/or perform color calibration processes for display screen 60. Calibration module 212 comprises sensing module 216, test module 217, and adjustment module 218. Sensing module 216 is configured to interface with sensing device(s) 92 to read and/or detect a current color displayed on display screen 60 (e.g., a light frequency value). Test module 217 is configured to display a predetermined color value on at least a portion of display screen 60 and compare the detected value (via sensing device(s) 92) with the expected or predetermined value. Adjustment module 218 is configured to adjust and/or change the settings of electronic device 10 and/or display screen 60 to compensate for any detected color degradation.

In FIG. 2, color data 214 comprises detected color data 220, test color data 222 and calibration color data 224. Color data 214 can be stored in any format including, but not limited to, a relational database, an XML database, a file, a hash file, etc. Detected color data 220 comprises information associated with the color and/or light frequency value detected as being emitted by display screen 60 and read/detected sensing device(s) 92. Test color data 222 comprises information associated with one or more predetermined test colors and/or light frequency values used to test display screen 60 (e.g., representing a color intended to be output/emitted by display screen 60).

Calibration data 224 comprises information associated with calibrating and/or adjusting various settings of electronic device 10 and/or display screen 60. For example, in the embodiment illustrated in FIG. 2, calibration data 224 comprises trigger event data 221 and adjustment data 223. Trigger event data 221 comprises information, any activity and/or input which initiates color calibration processes for display screen 60. For example, in some embodiments, trigger event data 222 comprises information causing the calibration process to be performed in response to detecting electronic device 10 in a closed position. In some embodiments, a user may initiate a calibration trigger event by requesting electronic device 10 to calibrate the display screen 60. In some embodiments, a calibration trigger event automatically occurs on a pre-established periodic basis. Adjustment data 223 comprises information associated with adjusting and/or otherwise calibrating various settings of electronic device 10 and/or display screen 60 (e.g., a display or video driver setting) such that the actual color emitted by display screen 60 corresponds (exactly or within some predetermined threshold) to desired values (e.g., matching a particular test color value and/or falling within a predetermined range of particular test color values).

In some embodiments, calibration data 224 comprises test location data 226 having information associated with particular locations and/or portions of display screen 60 to test and/or present test colors for calibrating display screen 60. For example, in some embodiments, test location data 226 may identify that a particular test color indicated by test color data 222 be displayed on substantially all of display screen 60 or in one or more particular zones/regions of display screen 60. For example, in some embodiments, test colors may be displayed and analyzed concurrently and/or sequentially for different locations on display screen 60. In this embodiment, for example, the user may be prompted by calibration module 212 via a user interface (e.g., displayable on display screen 60) to sequentially locate sensing device 92₂ of mouse 14 at different locations on/near display screen 60 in response to displaying visible boundary lines/test zone indicators on display screen 60. In some embodiments, calibration module 212 may prompt the user to locate sensing device 92 near display screen 60 by instructing the user to close notebook computer 12 and/or position display member 30 adjacent to base member 32 such that display screen 60 is adjacent and/or next to keyboard 80 (e.g., facing keyboard 80), thereby placing sensing device 92, in close proximity to display screen 60.

Thus, in operation, calibration module 212 initiates calibration processes based on one or more calibration trigger events. Upon initiation of a calibration process, test module 217 accesses and/or otherwise test color 224 to identify a test color to be presented on display screen 60 (e.g., on the entire display screen 60 and/or a portion of display screen 60 in accordance with test location data 226). Test module 217 also interfaces with a video driver or other component of electronic device 10 to cause a particular test color as indicated by test color data 222 to be displayed on display screen 60. Calibration module 212 then initiates and/or otherwise causes sensing module 216 to read and/or identify the color presented on display screen 60. Sensing module 216 interfaces with one or more sensing device(s) 92 to read a light frequency transmitted by display screen 60. Test module 217 receives and/or otherwise obtains the frequency value read/detected by sensing device(s) 92 and stores the detected value as detected color data 220. Test module 217 compares the detected value to test color data 222 to determine whether any color degradation is present relative to display screen 60. If color degradation is present, adjustment module 218 calculates and/or otherwise determines any change in color output settings for electronic device 10 to compensate for the detected color degradation and stores the setting changes as adjustment data 223, which may then be accessed by a video driver or other output controller for outputting display content on display screen 60.

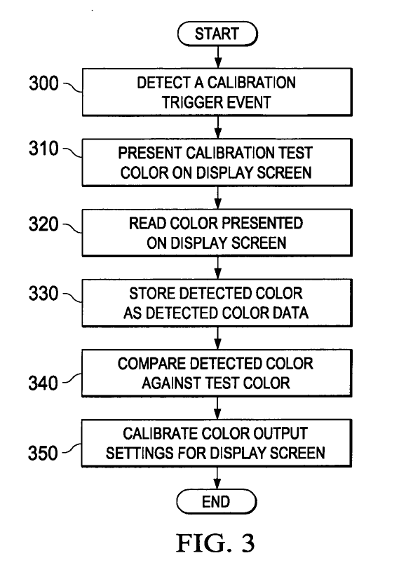

FIG. 3 illustrates an embodiment of a display color calibration method. The method begins with block 300 with calibration module 212 detecting a calibration trigger event. Calibration module 212 then initiates a color calibration process by initiating test module 217. Test module 217 identifies and presents a test color indicated by test color data 222 in a location on display screen 60 in accordance with test location data 226 (block 310). Sensing module 216 reads and/or otherwise determines a color value as presented/displayed on display screen 60 corresponding to the test color (e.g., by triggering and/or otherwise actuating sensing device(s) 92 to read a light frequency transmitted by display screen 60) (block 320). Sensing module 216 then stores the color read by sensing device(s) 92 as detected color data 220 (block 330). Calibration module 212 then compares detected color data 220 with the test color data 222 to determine whether display screen 60 is experiencing color degradation (block 340). If a color degradation is occurring, calibration module initiates adjustment module 218 to adjust and/or otherwise change or calibrate various settings associated with controlling the color output by display screen 60 to compensate for and/or mitigate the detected color degradation (block 350), with the process terminating thereafter.

The illustrative embodiments may be implemented in software and can be adapted to run on different platforms and operating systems. In particular, functions implemented by color calibration system 100, for example, may be provided by an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electro-magnetic, infrared, or semi-conductor system, apparatus, device, or propagation medium.

Thus, embodiments of color calibration system 100 are configured to enable color calibration of a display screen 60 to compensate for and/or otherwise mitigate detected color degradation of color values output by display screen 60. Further, calibration system 100 enables a calibration process to be performed based on one or more trigger events and provides color sensing devices 92 that may be embedded in the electronic device 10 itself and/or in another type of user input device generally associated with the electronic device 10 (e.g., keyboard 80, mouse 14, etc.) so that calibration system 100 may to obtain color value readings for calibrating the display screen 60 with little effort by the user (e.g., closing the electronic device 10 and/or placing a sensing device 92 near a particular location of the display screen 60).

What is claimed is:

1. A color calibration system, comprising:
an electronic device having a display screen;
a color sensing device disposed on the electronic device; and
a calibration module disposed in the electronic device to perform a color calibration process for the display screen based on a color value detected by the color sensing device.

2. The system of claim 1, wherein the color sensing device is located within a keyboard of the electronic device.

3. The system of claim 1, wherein the calibration module is configured to initiate the color calibration process in response to detecting a trigger event.

4. The system of claim 1, wherein the electronic device comprises a notebook computer, and wherein the calibration module is configured to initiate the color calibration process in response to detecting a closed position of the notebook computer.

5. The system of claim 1, wherein the calibration module is configured to initiate the color calibration process in response to a user request.

6. The system of claim 1, wherein the calibration module is configured to cause a test color to be output by the display screen for the calibration process.

7. The system of claim 1, wherein the color sensing device reads a light frequency transmitted by the viewable surface to identify the color degradation.

8. The system of claim 1, wherein the calibration module is configured to cause a test color to be output by the display screen at a particular location on the display screen for the calibration process.

9. The system of claim 1, wherein the calibration module is configured to compare the color value detected by the color sensing device to predetermined test color data.

10. The system of claim 1, wherein the calibration module is configured to receive a detected color value from a mouse.

11. A color calibration method, comprising:
automatically initiating a color calibration process on a display screen of an electronic device in response to a calibration trigger event detected by the electronic device, the calibration process analyzing a color value output by the display screen using a color sensing device disposed on a user input device associated with the electronic device.

12. The method of claim 11, further comprising detecting the color value using a color sensing device disposed within a keyboard of the electronic device.

13. The method of claim 11, further comprising detecting the color value using a color sensing device disposed in a mouse.

14. The method of claim 11, further comprising reading a frequency of light output by the display screen using the color sensing device.

15. The method of claim 11, further comprising determining a location on the display screen to display a calibration test color.

16. The method of claim 11, further comprising prompting a user to place the color sensing device near a particular location on the display screen displaying a calibration test color.

17. The method of claim 11, wherein the electronic device comprises a notebook computer, and further comprising initiating the calibration process in response to the calibration trigger event comprising a closed condition of the notebook computer.

18. A computer-readable medium having stored thereon an instruction set to be executed, the instruction set, when executed by a processor, causes the processor to:
automatically initiate a color calibration process on a display screen of an electronic device in response to a calibration trigger event detected by the electronic device, the calibration process analyzing a color value output by the display screen using a color sensing device disposed on a user input device associated with the electronic device.

19. The computer-readable medium of claim 18, wherein the instruction set, when executed by the processor, causes the processor to detect the color value using a color sensing device disposed within a keyboard of the electronic device.

20. The computer-readable medium of claim 18, wherein the instruction set, when executed by the processor, causes the processor to detect the color value using a color sensing device disposed within a mouse.

21. The computer-readable medium of claim 18, wherein the instruction set, when executed by the processor, causes the processor to prompt a user to place the color sensing device near a particular location on the display screen displaying a calibration test color.

22. A color calibration system, comprising:
an electronic device having a display screen;
a calibration module disposed in the electronic device to perform a color calibration process for the display screen, the calibration module configured to prompt a user to place a color sensing device near the display screen to detect a displayed calibration test color output by the display screen.

23. The system of claim 22, wherein the electronic device comprises a notebook computer, and wherein the prompt comprises an instruction for the user to place the notebook computer in a closed position.

24. The system of claim 22, wherein the prompt comprises requesting that the user place the color sensing device near a particular location on the display screen displaying the calibration test color.

25. The system of claim 22, wherein color sensing device is disposed within a keyboard of the electronic device.

26. The system of claim 22, wherein the electronic device comprises a notebook computer, and wherein the color sensing device is disposed on a working surface of the notebook computer.
